(19) United States
(12) Patent Application Publication
(10) Pub. No.: US 2022/0303089 A1
(43) Pub. Date: Sep. 22, 2022

(54) ENHANCEMENTS ON TRACKING REFERENCE SIGNAL (TRS)-BASED POWER SAVING DESIGN FOR IDLE MODE OR INACTIVE MODE USER EQUIPMENT (UE)

(71) Applicant: MEDIATEK INC., Hsin-Chu (TW)

(72) Inventors: Yi-Ju Liao, Hsin-Chu (TW); Wei-De Wu, Hsin-Chu (TW)

(21) Appl. No.: 17/584,270

(22) Filed: Jan. 25, 2022

Related U.S. Application Data
(60) Provisional application No. 63/163,974, filed on Mar. 22, 2021.

(51) Int. Cl. H04L 5/00; H04W 72/04; H04W 68/02; H04W 48/16

(52) U.S. Cl. CPC H04L 5/0048; H04W 72/042; H04W 68/02; H04W 48/16

(57) ABSTRACT

A method for providing tracking reference signal (TRS) availability information to idle mode or inactive mode user equipment (UE) is proposed to enhance the TRS-based power saving design. A UE operates in an idle mode or an inactive mode of communication with a wireless communication network, and receives a system information block (SIB) from the wireless communication network when the UE is operating in the idle mode or the inactive mode. The received SIB includes TRS configuration. The UE determines whether a TRS is present on a TRS occasion indicated by the TRS configuration based on TRS availability information signaled from the wireless communication network, and receives the TRS from the wireless communication network in response to determining that the TRS is present.

### CROSS REFERENCE TO RELATED APPLICATION

This application claims priority under 35 U.S.C. § 119 from U.S. Provisional Application No. 63/163,974, entitled “Design on RS Availability Signaling for Idle/Inactive Mode UE,” filed on Mar. 22, 2021, the subject matter of which is incorporated herein by reference.

### TECHNICAL FIELD

The disclosed embodiments relate generally to wireless communication systems, and, more particularly, to enhancements on tracking reference signal (TRS)-based power saving design for idle mode or inactive mode user equipment (UE).

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3rd generation partner project (3GPP) network normally includes a hybrid of 2G/3G/4G systems. With the optimization of the network design, many improvements have developed over the evolution of various standards. The next generation mobile network (NGMN) board, has decided to focus the future NGMN activities on defining the end-to-end requirements for 5G new radio (NR) systems.

In 5G NR, various types of reference signals, including demodulation reference signals (DMRS), phase-tracking reference signals (PT-RS), sounding reference signals (SRS), channel state information reference signals (CSI-RS), and tracking reference signals (TRS), are introduced, and each type of reference signals serves a specific purpose. For example, TRS are sparse reference signals intended to assist connected-mode UE in time and frequency tracking, and the TRS configuration is carried in specific information element (IE) available only through radio resource control (RRC) signaling in connected mode. On the other hand, an idle-mode UE may need to receive several synchronization signal blocks (SSBs) to acquire sufficient information for time and frequency tracking before each Paging Occasion (PO) and SSB-based measurement timing configuration (SMTC) window. Since SSBs are periodic signals, idle-mode UE needs to wake up from sleep mode for several times to receive SSBs. Even though idle-mode UE's power consumption can be saved by entering sleep mode in the times where no SSB is transmitted, the constant waking up for SSB reception is still inefficient in power saving.

A solution is sought.

### SUMMARY

A method for providing tracking reference signal (TRS) availability information to idle mode or inactive mode user equipment (UE) is proposed to enhance the TRS-based power saving design.

From UE's perspective: a UE operates in an idle mode or an inactive mode of communication with a wireless communication network, and receives a system information block (SIB) from the wireless communication network when the UE is operating in the idle mode or the inactive mode. The received SIB comprises TRS configuration. The UE determines whether a TRS is present on a TRS occasion indicated by the TRS configuration based on TRS availability information signaled from the wireless communication network, and receives the TRS from the wireless communication network in response to determining that the TRS is present.

In one example, the TRS availability information is signaled from the wireless communication network via the SIB, another SIB, a paging early indication (PEI), or a paging downlink control information (DCI).

In one example, the UE determines whether the TRS occasion is within a window on time domain in response to determining that the TRS is present, and receives the TRS in response to determining that the TRS occasion is within the window. The window is configured through radio resource control (RRC) signaling, or configured using a pre-defined value, or indicated by the TRS availability information. The TRS availability information is valid to the UE within the window.

In one example, the UE determines whether the TRS is present on the TRS occasion indicated by the TRS configuration, by: determining that the TRS is present on the TRS occasion indicated by the TRS configuration in response to detecting the PEI or in response to the detected PEI indicating that the TRS is present; and determining that the TRS is not present on the TRS occasion indicated by the TRS configuration in response to not detecting the PEI or in response to the detected PEI indicating that the TRS is not present.

In one example, the UE determines whether the TRS is present on the TRS occasion indicated by the TRS configuration, by: determining that the TRS is present on the TRS occasion indicated by the TRS configuration in response to detecting the paging DCI or in response to the detected paging DCI indicating that the TRS is present; and determining that the TRS is not present on the TRS occasion indicated by the TRS configuration in response to not detecting the paging DCI or in response to the detected paging DCI indicating that the TRS is not present.

In one example, the UE stops receiving the TRS from the wireless communication network in response to determining that the TRS is not present.

In one example, the same TRS availability information is signaled from the wireless communication network on a plurality of beams.

From network's perspective: the wireless communication network transmits a SIB to the UE when the UE is operating in an idle mode or an inactive mode of communication with the wireless communication network. The transmitted SIB comprises TRS configuration. The wireless communication network provides TRS availability information to the UE through SIB signaling or layer-1 (L1) signaling. The TRS availability information indicates to the UE whether a TRS is present on a TRS occasion indicated by the TRS configuration. The wireless communication network transmits the TRS to the UE based on the TRS configuration and the TRS availability information.

In one example, the TRS availability information is signaled to the UE via the SIB, another SIB, a PEI, or a paging DCI.

In one example, the wireless communication network provides a window on time domain to the UE through RRC signaling or through the TRS availability information, and transmits the TRS when the TRS occasion is within the window.

In one example, the wireless communication network stops transmitting the TRS to the UE in response to the TRS availability information indicating that the TRS is not present on the TRS occasion indicated by the TRS configuration, or in response to the TRS occasion is not within the window.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G new radio (NR) network 100 supporting idle-mode tracking reference signal (TRS) in accordance with aspects of the current invention.

FIG. 2 is a simplified block diagram of wireless devices 201 and 211 in accordance with embodiments of the present invention.

FIG. 3 illustrates the concept of providing TRS in idle mode for additional power saving in accordance with one novel aspect of the present invention.

FIG. 4 illustrates the provision of TRS availability information via system information (SI) in accordance with one novel aspect of the present invention.

FIG. 5 illustrates the provision of TRS availability information via PEI in accordance with one novel aspect of the present invention.

FIG. 6 illustrates the provision of TRS availability information via paging DCI in accordance with one novel aspect of the present invention.

FIG. 7 is a flow chart of a method for providing TRS availability information to idle/inactive-mode UE from UE perspective in accordance with one novel aspect of the present invention.

FIG. 8 is a flow chart of a method for providing TRS availability information to idle/inactive-mode UE from network perspective in accordance with one novel aspect of the present invention.

### DETAILED DESCRIPTION

Reference will now be made in detail to some embodiments of the invention, examples of which are illustrated in the accompanying drawings.

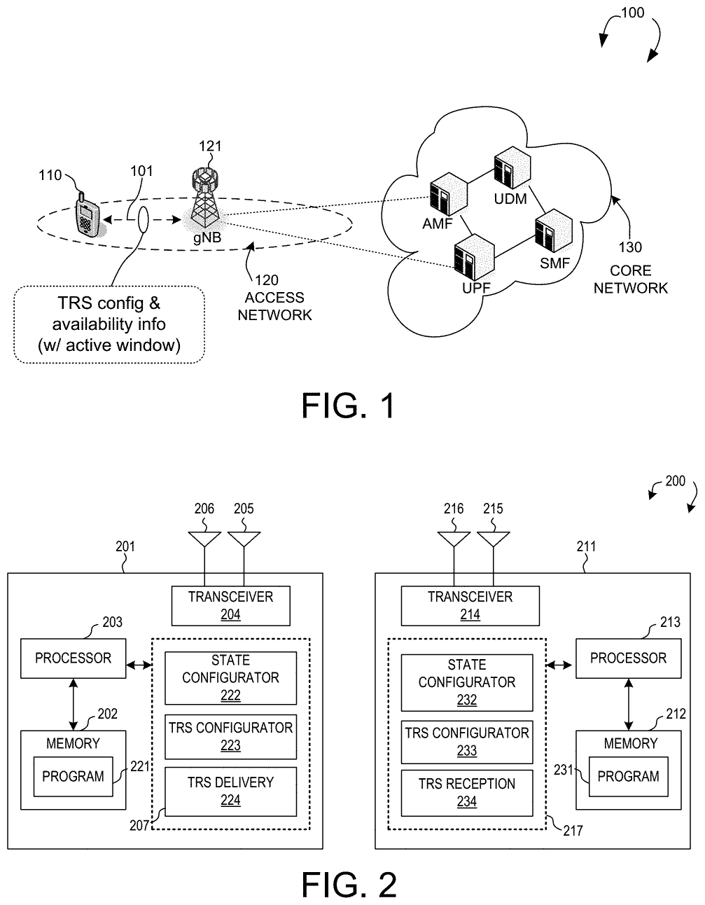

FIG. 1 illustrates an exemplary 5G new radio (NR) network 100 supporting idle-mode tracking reference signal (TRS) in accordance with aspects of the current invention. The 5G NR network 100 comprises a user equipment (UE) 110 communicatively connected to a gNB 121 operating in a licensed band (e.g., 30 GHz˜300 GHz for mmWave) of an access network 120 which provides radio access using a radio access technology (RAT) (e.g., the 5G NR technology). The access network 120 is connected to a 5G core network 130 by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy. The UE 110 may be a smart phone, a wearable device, an Internet of things (IoT) device, and a tablet, etc. Alternatively, UE 110 may be a notebook (NB) or personal computer (PC) inserted or installed with a data card which includes a modem and radio frequency (RF) transceiver(s) to provide the functionality of wireless communication.

The gNB 121 may provide communication coverage for a geographic coverage area in which communications with the UE 110 is supported via a communication link 101. The communication link 101 between the gNB 121 and the UE 110 may utilize one or more frequency carriers to form one or more cells (e.g., a PCell and one or more SCells). The communication link 101 shown in the 5G NR network 100 may include uplink transmissions from the UE 110 to the gNB 121 (e.g., on the Physical Uplink Control Channel (PUCCH) or Physical Uplink Shared Channel (PUSCH)) and/or downlink transmissions from the gNB 121 to the UE 110 (e.g., on the Physical Downlink Control Channel (PDCCH) or Physical Downlink Shared Channel (PDSCH)).

In accordance with one novel aspect, the downlink transmissions over the communication link 101 may carry the TRS configuration (which includes the information of TRS occasions, i.e., the time-frequency locations of TRS) and the TRS availability information (i.e., information concerning whether the TRS is present on a TRS occasion indicated by the TRS configuration), when the UE 110 is operating in an idle mode (e.g., the RRC_IDLE mode) or an inactive mode (e.g., the RRC_INACTIVE mode). The idle-mode or inactive-mode UE 110 may receive TRS from the wireless communication network based on the TRS configuration and the TRS availability information, and performs time and/or frequency tracking in the idle/inactive mode based on the received TRS. Based on the performed time and/or frequency tracking, the idle-mode or inactive mode UE 110 may enter a sleep mode for a period of time spanning one or more occasions configured for Synchronization Signal Block (SSB) reception, to reduce power consumption. In one example, the TRS configuration is carried in a system information block (SIB) (e.g., an existing SIB, such as type-1 SIB, or a new SIB, such as type-15 SIB), while the TRS availability information is carried in the same SIB, another SIB, a paging early indication (PEI), or a paging downlink control information (DCI).

In accordance with another novel aspect, the downlink transmissions over the communication link 101 may further carry an indication active window that specifies a period of time in which the UE considers the TRS availability information valid, when the UE 110 is operating in the idle mode or the inactive mode. In one example, the indication active window may be carried via RRC signaling. In another example, the indication active window may be configured using a pre-defined value, or indicated by the TRS availability information.

FIG. 2 is a simplified block diagram of wireless devices 201 and 211 in accordance with embodiments of the present invention. For wireless device 201 (e.g., a base station), antennae 205 and 206 transmit and receive radio signal. RF transceiver module 204, coupled with the antennae 205 and 206, receives RF signals from the antennae 205 and 206, converts them to baseband signals and sends them to processor 203. RF transceiver 204 also converts received baseband signals from the processor 203, converts them to RF signals, and sends out to antennae 205 and 206. Processor 203 processes the received baseband signals and invokes different functional modules and circuits 207 to perform features in wireless device 201. Memory 202 stores program instructions and data 221 to control the operations of wireless device 201.

Similarly, for wireless device 211 (e.g., a UE), antennae 215 and 216 transmit and receive RF signals. RF transceiver module 214, coupled with the antennae 215 and 216, receives RF signals from the antennae 215 and 216, converts them to baseband signals and sends them to processor 213. The RF transceiver 214 also converts received baseband signals from the processor 213, converts them to RF signals, and sends out to antennae 215 and 216. Processor 213 processes the received baseband signals and invokes different functional modules and circuits 217 to perform features in wireless device 211. Memory 212 stores program instructions and data 231 to control the operations of the wireless device 211.

In the wireless devices 201 and 211, the functional modules and circuits 207 and 217 can be implemented and configured to perform embodiments of the present invention. In the example of FIG. 2, the wireless device 201 is a base station (e.g., gNB) that includes a state configurator circuit 222 that configures the wireless device 211 to operate in the idle/inactive mode of communication with the wireless device 201, a TRS configurator circuit 223 that transmits the TRS configuration, the TRS availability information, and the indication active window to the wireless device 211, and a TRS delivery circuit 224 that transmits the TRS configuration to the wireless device 211. The wireless device 211 is a UE that includes a state configurator circuit 232 that configures the wireless device 211 to operate in the idle/inactive mode of communication with the wireless device 201, a TRS configurator circuit 233 that receives the TRS configuration, the TRS availability information, and the indication active window from the wireless device 201 when the wireless device 211 is in the idle/inactive mode, and a TRS reception circuit 234 that receives a TRS from the wireless device 201 based on the TRS configuration and the TRS availability information when the wireless device 211 is in the idle/inactive mode. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 221 and 231), allow base station 201 and UE 211 to perform embodiments of the present invention.

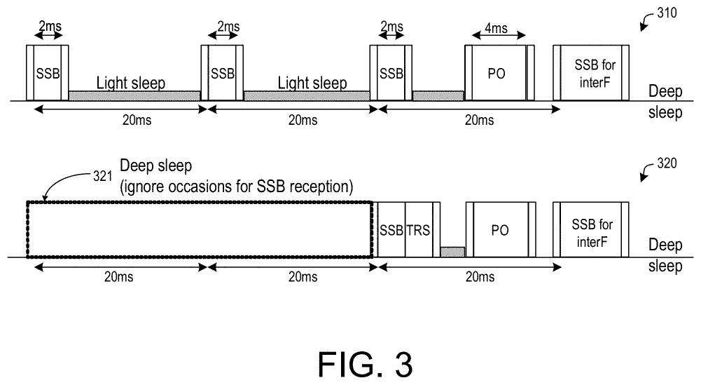

FIG. 3 illustrates the concept of providing TRS for additional power saving in accordance with one novel aspect of the present invention. Diagram 310 of FIG. 3 depicts the SSB transmission scheme in NR, where LOOP operations (including AGC, FTL, and TTL) and measurements (MEAS) can only be performed in certain occasions, e.g., during SSB bursts. UE wakes up for SSBs, e.g., every 20 ms (every 2 radio frames). UE may enter light sleep mode (e.g., a first power saving mode with higher power consumption) in the gap between the SSBs for LOOP/MEAS and paging occasion (PO). As shown in diagram 320 of FIG. 3, when TRS for idle/inactive-mode UE is introduced, UE can skip one or more occasions configured for SSB reception, e.g., entering a deep sleep mode (e.g., a second power saving mode with lower power consumption) in 321. Note that Low-SINR UEs need to wake up earlier, i.e., monitor more SSB bursts (larger N_{SSB}) before being able to decode paging message. High-SINR UEs may wake up later before PO monitoring.

To be more specific, TRS is a periodic non-zero-power (NZP)-CSI-RS-ResourceSet configured with trs-Info and composed of 2 or 4 nzp-CSI-RS-Resource. Each nzp-CSI-RS-Resource resource is 1-port and of density 3. A UE (e.g., an idle-mode UE) can be configured with one or more NZP CSI-RS set(s) with trs-info. There should be no CSI-ReportConfig for TRS (no need to report CSI for TRS). Periodic TRS can be configured with a periodicity of 10, 20, 40, or 80 ms. The bandwidth (BW) of TRS is the minimum of 52 and N^{size}_{BWP,i} resource blocks, or is equal to N^{size}_{BWP,i} resource blocks.

However, although the TRS configuration received via a SIB includes the information of TRS occasions, the gNB may not always need to or want to transmit TRS on the TRS occasions indicated in the TRS configuration. This is where the TRS availability information and the indication active window come in handy, as these additional information can tell the idle/inactive-mode UE whether the TRS is present on a TRS occasion indicated by the TRS configuration or not. In one embodiment, the TRS availability information may be implicitly signaled (or called one-stage signaling) to the idle/inactive-mode UE. That is, as long as a SIB including TRS configuration is received and the TRS configuration includes information of at least one TRS occasion, the UE assumes that a TRS is present on each TRS occasion indicated in the TRS configuration. Otherwise, if a SIB including TRS configuration is received but the TRS configuration includes no information of any TRS occasion, the UE assumes that no TRS will be transmitted in a following period of time. In another embodiment, the TRS availability information may be explicitly signaled (or called two-stage signaling) to the idle/inactive-mode UE. That is, one SIB may be used to carry the TRS configuration, while the other SIB or the same SIB may be used to carry the TRS availability information. For example, a type-x SIB may carry the TRS configuration which includes information of a plurality of TRS occasions, and a type-y SIB may carry the TRS availability information indicating which of the TRS occasions have TRS present on them.

To further clarify, if the indication active window is configured by network, the idle/inactive-mode UE may expect that the TRS availability information is valid during the indication active window. The benefit of introducing the indication active window is that it can reduce the possibility that the network is forced to transmit TRS on the configured TRS occasion(s) when there is no connected-mode UE. The indication active window may be configured through an RRC signaling which specifies the length of the indication active window, or the starting time and the length of the indication active window, or the starting time and the ending time of the indication active window. The starting time and the ending time of the indication active window may be P and K time units (e.g., symbols, or slots, etc.), respectively, subsequent to the reception of the RRC signaling. In one example, the reference point of the starting time may refer to the DCI or PDSCH for the RRC signaling reception. In one example, the P time units may be a fixed value (i.e., not configurable) when the RRC signaling specifies only the length of the indication active window. In one example, the length of the indication active window may be N (N≥1) paging cycles, M (M≥1) SSB periods, or a number of radio frames/slots/ms.

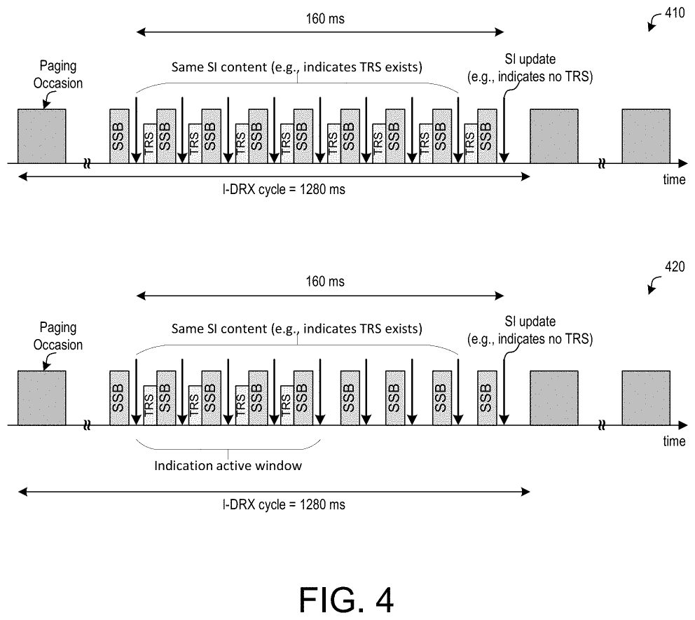

FIG. 4 illustrates the provision of TRS availability information via system information (SI) in accordance with one novel aspect of the present invention. Diagram 410 of FIG. 4 depicts the TRS availability information provided without the indication active window being supported or configured. The TRS availability information is provided in each SI, i.e., via a SIB (e.g., type-1 SIB), wherein the first eight SIs contain the same content, i.e., the same TRS availability information indicating that TRS is present on the configured TRS occasion. Next, the ninth SI is updated to indicate that TRS is not present on the configured TRS occasion, and then, the idle/active-mode UE stops receiving TRS. Diagram 420 of FIG. 4 depicts the TRS availability information provided with the indication active window. Unlike diagram 410, the idle/active-mode UE only receives the TRS on the configured TRS occasions following the first SI within the indication active window, and does not receive the TRS on the configured TRS occasions outside the indication active window.

It is observed that, in the embodiment of FIG. 4, the TRS existence may not be much helpful for power saving of the idle/inactive-mode UE when the occasion for receiving SI update is too close to a next PO reception and the UE still needs to receive multiple SSBs. In addition, the SI signaling may not be dynamic enough to provide the network flexibility to update the TRS availability information, especially when the I-DRX cycle is short. Therefore, the present application also proposes to provide the TRS availability information via a DCI-based PEI. When a PEI is detected, the idle/inactive-mode UE assumes that TRS is present on the TRS occasions indicated in the TRS configuration for a time duration based on the received TRS availability information in the detected PEI. Otherwise, when no detecting any PEI, the idle/inactive-mode UE assumes that TRS is not present on the TRS occasions indicated in the TRS configuration. Also, the indication active window may be carried in a PEI as well, to provide the network flexibility. That is, the network may further configure the indication active window to the idle/inactive-mode UE, and the UE may expect that the TRS availability information is valid within the indication active window. Otherwise, if the indication active window is not supported or configured, the UE may assume that the TRS availability information is valid until the next PEI monitoring occasion corresponding to the PO of the next I-DRX cycle.

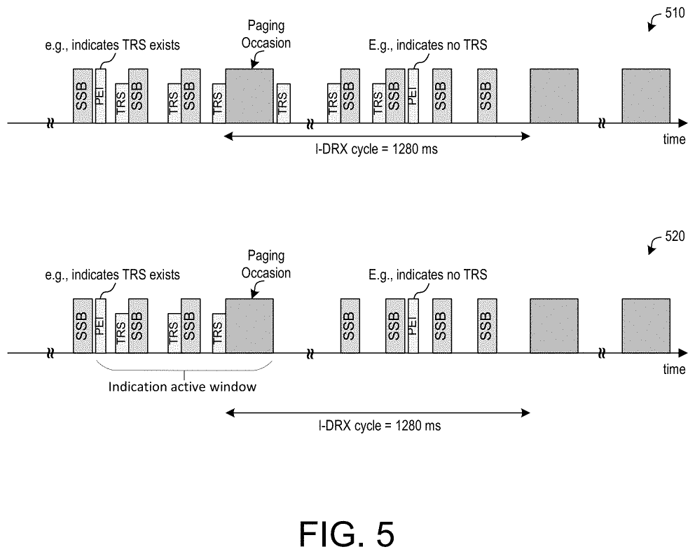

FIG. 5 illustrates the provision of TRS availability information via PEI in accordance with one novel aspect of the present invention. Diagram 510 of FIG. 5 depicts the TRS availability information provided without the indication active window being supported or configured. The TRS availability information is provided in the first PEI indicating that TRS is present on the configured TRS occasions. In response the first PEI, the idle/inactive-mode UE receives the TRS on the configured TRS occasions until the next PEI monitoring occasion. Next, the TRS availability information is updated in the second PEI indicating that TRS is not present on the configured TRS occasions. In response the second PEI, the idle/inactive-mode UE stops receiving the TRS on the configured TRS occasions. Diagram 520 of FIG. 5 depicts the TRS availability information provided with the indication active window. Unlike diagram 510, the idle/active-mode UE only receives the TRS on the configured TRS occasions following the first PEI within the indication active window, and does not receive the TRS on the configured TRS occasions outside the indication active window.

Moreover, the present application also proposes to provide the TRS availability information via a paging DCI. When a paging DCI is detected, the idle/inactive-mode UE assumes that TRS is present on the TRS occasions indicated in the TRS configuration for a time duration based on the received TRS availability information in the detected paging DCI. In particular, the reserved bits of a paging DCI may be used to carry the TRS availability information, so that network backward compatibility can be guaranteed. Also, the indication active window may be carried in a paging DCI as well, to provide the network flexibility. That is, the network may further configure the indication active window to the idle/inactive-mode UE, and the UE may expect that the TRS availability information is valid within the indication active window. Otherwise, if the indication active window is not supported or configured, the UE may assume that the TRS availability information is valid until the PO of the next I-DRX cycle.

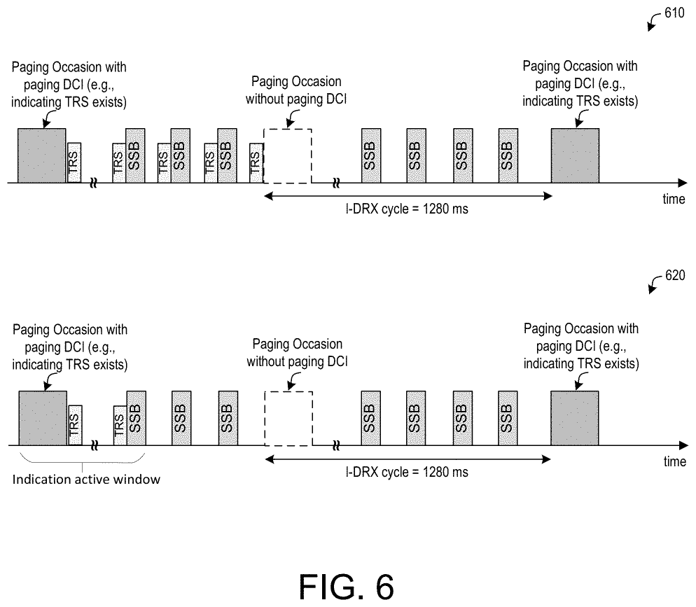

FIG. 6 illustrates the provision of TRS availability information via paging DCI in accordance with one novel aspect of the present invention. Diagram 610 of FIG. 6 depicts the TRS availability information provided without the indication active window being supported or configured. The TRS availability information is provided in the paging DCI in the first PO, wherein the paging DCI indicates that TRS is present on the configured TRS occasions. In response the paging DCI, the idle/inactive-mode UE receives the TRS on the configured TRS occasions until the PO of the next I-DRX cycle. After that, the TRS availability information is updated as there is no paging DCI detected in the PO of the next I-DRX cycle. In response the not detecting a paging DCI in the PO, the idle/inactive-mode UE stops receiving the TRS on the configured TRS occasions. Diagram 620 of FIG. 6 depicts the TRS availability information provided with the indication active window. Unlike diagram 610, the idle/active-mode UE only receives the TRS on the configured TRS occasions following the detected paging DCI within the indication active window, and does not receive the TRS on the configured TRS occasions outside the indication active window.

For all types of signaling schemes for providing the TRS availability information, the idle/inactive-mode UE assumes that the same TRS availability information is signaled on all beams in the multi-beam operation. In addition, if the indication active window is configured, the UE does not expect to receive another RS availability information different from the previously received one during the indication active window.

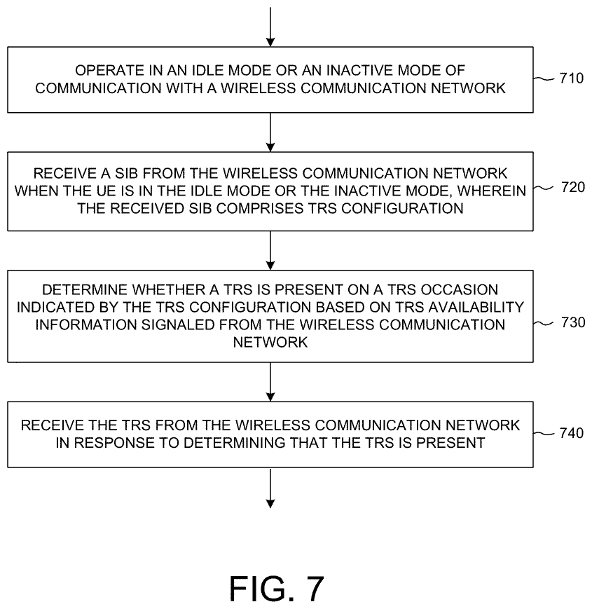

FIG. 7 is a flow chart of a method for providing TRS availability information to idle/inactive-mode UE from UE perspective in accordance with one novel aspect of the present invention. In step 710, a UE operates in an idle mode (e.g., RRC_IDLE mode) or an inactive mode (e.g., RRC_INACTIVE mode) of communication with a wireless communication network (e.g., 5G NR network). In step 720, the UE receives a SIB from the wireless communication network when the UE is operating in the idle mode or the inactive mode, wherein the received SIB comprises TRS configuration. In step 730, the UE determines whether a TRS is present on a TRS occasion indicated by the TRS configuration based on TRS availability information signaled from the wireless communication network. In step S740, the UE receives the TRS from the wireless communication network in response to determining that the TRS is present.

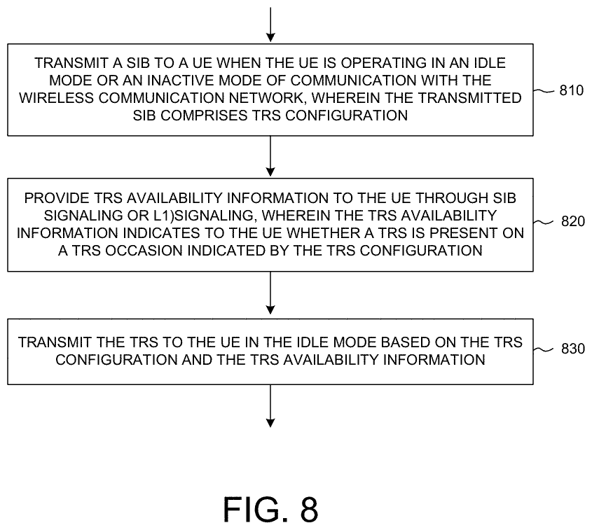

FIG. 8 is a flow chart of a method for providing TRS availability information to idle/inactive-mode UE from network perspective in accordance with one novel aspect of the present invention. In step 810, a wireless communication network transmits a SIB to a UE when the UE is operating in an idle mode or an inactive mode of communication with the wireless communication network, wherein the transmitted SIB comprises TRS configuration. In step 820, the wireless communication network provides TRS availability information to the UE through SIB signaling or L1 signaling, wherein the TRS availability information indicates to the UE whether a TRS is present on a TRS occasion indicated by the TRS configuration. In step 830, the wireless communication network transmits the TRS to the UE based on the TRS configuration and the TRS availability information.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
operating in an idle mode or an inactive mode of communication with a wireless communication network by a user equipment (UE);
receiving a system information block (SIB) from the wireless communication network when the UE is operating in the idle mode or the inactive mode, wherein the received SIB comprises tracking reference signal (TRS) configuration;
determining whether a TRS is present on a TRS occasion indicated by the TRS configuration based on TRS availability information signaled from the wireless communication network; and
receiving the TRS from the wireless communication network in response to determining that the TRS is present.

2. The method of claim 1, wherein the TRS availability information is signaled from the wireless communication network via the SIB, another SIB, a paging early indication (PEI), or a paging downlink control information (DCI).

3. The method of claim 1, further comprising:
determining whether the TRS occasion is within a window on time domain in response to determining that the TRS is present;
wherein the receiving of the TRS is performed in response to determining that the TRS occasion is within the window.

4. The method of claim 3, wherein the window is configured through radio resource control (RRC) signaling, or configured using a pre-defined value, or indicated by the TRS availability information.

5. The method of claim 3, wherein the TRS availability information is valid to the UE within the window.

6. The method of claim 2, wherein the determining of whether the TRS is present on the TRS occasion indicated by the TRS configuration comprises:
determining that the TRS is present on the TRS occasion indicated by the TRS configuration in response to detecting the PEI or in response to the detected PEI indicating that the TRS is present; and
determining that the TRS is not present on the TRS occasion indicated by the TRS configuration in response to not detecting the PEI or in response to the detected PEI indicating that the TRS is not present.

7. The method of claim 2, wherein the determining of whether the TRS is present on the TRS occasion indicated by the TRS configuration comprises:
determining that the TRS is present on the TRS occasion indicated by the TRS configuration in response to detecting the paging DCI or in response to the detected paging DCI indicating that the TRS is present; and
determining that the TRS is not present on the TRS occasion indicated by the TRS configuration in response to not detecting the paging DCI or in response to the detected paging DCI indicating that the TRS is not present.

8. The method of claim 1, further comprising:
stopping receiving the TRS from the wireless communication network in response to determining that the TRS is not present.

9. The method of claim 1, wherein the same TRS availability information is signaled from the wireless communication network on a plurality of beams.

10. A user equipment (UE), comprising:
a communication operation circuit that configures the UE to operate in an idle mode or an inactive mode of communication with a wireless communication network;
a receiver circuit that receives a system information block (SIB) from the wireless communication network when the UE is in the idle mode or the inactive mode, wherein the received SIB comprises tracking reference signal (TRS) configuration; and
a TRS reception circuit that determines whether a TRS is present on a TRS occasion indicated by the TRS configuration based on TRS availability information signaled from the wireless communication network, and receives the TRS from the wireless communication network in response to determining that the TRS is present.

11. The UE of claim 10, wherein the TRS availability information is signaled from the wireless communication network via the SIB, another SIB, a paging early indication (PEI), or a paging downlink control information (DCI).

12. The UE of claim 10, wherein the UE determines whether the TRS occasion is within a window on time domain in response to determining that the TRS is present, and the receiving of the TRS is performed in response to determining that the TRS occasion is within the window.

13. The UE of claim 12, wherein the window is configured through radio resource control (RRC) signaling, or configured using a pre-defined value, or indicated by the TRS availability information.

14. The UE of claim 11, wherein the determining of whether the TRS is present on the TRS occasion indicated by the TRS configuration comprises:
determining that the TRS is present on the TRS occasion indicated by the TRS configuration in response to detecting the PEI or in response to the detected PEI indicating that the TRS is present; and
determining that the TRS is not present on the TRS occasion indicated by the TRS configuration in response to not detecting the PEI or in response to the detected PEI indicating that the TRS is not present.

15. The UE of claim 11, wherein the determining of whether the TRS is present on the TRS occasion indicated by the TRS configuration comprises:
determining that the TRS is present on the TRS occasion indicated by the TRS configuration in response to detecting the paging DCI or in response to the detected paging DCI indicating that the TRS is present; and
determining that the TRS is not present on the TRS occasion indicated by the TRS configuration in response to not detecting the paging DCI or in response to the detected paging DCI indicating that the TRS is not present.

16. The UE of claim 10, wherein the UE stops receiving the TRS from the wireless communication network in response to determining that the TRS is not present.

17. A method, comprising:
transmitting a system information block (SIB) to a user equipment (UE) by a wireless communication network when the UE is operating in an idle mode or an inactive mode of communication with the wireless communication network, wherein the transmitted SIB comprises tracking reference signal (TRS) configuration;
providing TRS availability information to the UE through SIB signaling or layer-1 (L1) signaling, wherein the TRS availability information indicates to the UE whether a TRS is present on a TRS occasion indicated by the TRS configuration; and
transmitting the TRS to the UE based on the TRS configuration and the TRS availability information.

18. The method of claim 17, wherein the TRS availability information is signaled to the UE via the SIB, another SIB, a paging early indication (PEI), or a paging downlink control information (DCI).

19. The method of claim 17, further comprising:
providing a window on time domain to the UE through radio resource control (RRC) signaling or through the TRS availability information;
wherein the TRS is transmitted when the TRS occasion is within the window.

20. The method of claim 19, further comprising:
stopping transmitting the TRS to the UE in response to the TRS availability information indicating that the TRS is not present on the TRS occasion indicated by the TRS configuration, or in response to the TRS occasion is not within the window.
